(19) United States
(12) Patent Application Publication
(10) Pub. No.: US 2017/0349272 A1
(43) Pub. Date: Dec. 7, 2017

(54) TRICOPTER-TYPE ROTARY WING DRONE

(71) Applicant: EZNOV, Metz (FR)

(72) Inventors: Eric LAURENT, Rambouillet (FR); Thomas LEGRAND, Metz (FR)

(73) Assignee: EZNOV

(21) Appl. No.: 15/175,803

(22) Filed: Jun. 7, 2016

(51) Int. Cl. B64C 27/28; B64C 29/00; B64C 39/02

(52) U.S. Cl. CPC B64C 27/28; B64C 39/024; B64C 29/0033; B64C 2201/024; B64C 2201/104; B64C 2201/108; B64C 2201/028

(57) ABSTRACT

The tricopter type rotary-wing drone includes three arms connected to a frame. Each of the free ends of the arms support a rotor with an axis perpendicular to the respective free end. The rotor is driven in rotation by a motor connected to power supply. The arms are pivotally mounted on the frame. Two arms automatically drive the rotor supported by their respective free ends into a position in which its axis forms an angle between −30° and +150° with the plane of the frame. The third arm automatically pivots, if necessary, into a position in which its free end is spaced apart from the apex being considered of the triangle by an angle between −60° and +60°.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a tricopter type rotary-wing drone including three arms connected to a frame through one of their ends and extending in the plane of the frame according to a configuration in which their free ends are each located at an apex of a triangle, each of the free ends supporting a rotor with an axis perpendicular to said free end and driven in rotation by a motor connected to supply means.

### 2. Description of Related Art Including Information Disclosed Under 37 CFR 1.97 and 37 CFR 1.98

The management of devices such as drones represents at present an exponentially increasing activity. Though in the beginning they were primarily dedicated for military purposes, these devices are now also establishing themselves in the civil field. Thus, no fewer than two hundred new applications have been disclosed in three years and the usages that can be contemplated seem to be limitless.

By way of an example, some farmers are already using drones to monitor their crops and rely on the aerial photographs being obtained for identifying the actions to be taken and namely for accurately determining the input requirements. The use of drones is also becoming more common in the field of public safety, where they permit the police forces to use aerial photographs, for example of crime or fire scenes, or border areas, within the framework of their investigations. Other less developed, but also very promising markets, are also represented for example in the field of real estate, civil engineering or mountain rescue.

Although many innovations have been made in recent years in order to adapt the drone-type devices to the different civil applications considered, many drawbacks appearing as a hindrance for their development, still remain.

In particular, it has been observed that the quality of the aerial photographs obtained by the implementation of multicopter-type drones was not always satisfactory because of the often unstable nature of the flight being performed. Therefore, the images obtained are often unclear and do not permit to properly view some potentially important details.

On the other hand, the “delta wing”-type drones require much space during the take-off and landing phases, and involve a hand-launch that can cause serious injury to the operator. In addition, they are characterized by a linear flight speed, which makes them difficult to be controlled in case the operator wants to take the control during a mission.

### BRIEF SUMMARY OF THE INVENTION

The aim of the present invention is to cope with these various drawbacks by providing a drone that can be used irrespective of the environment and the available space, permitting a constantly flat flight as well as a stationary flight with a 0-degree or inclined pitch permitting to guarantee an excellent quality of the photographs as well as their completeness. Another aim of the present invention is to provide such a drone that is easy to be used, at an affordable cost and perfectly safe for the operator.

To this end, the invention relates to a drone of the type indicated in the preamble, characterized in that said arms are pivotally mounted on said frame, two of them being capable of automatically driving the rotor supported by their free end into a position in which its axis forms an angle between −30° and +150° with the plane of the frame and the third of them being capable of automatically pivoting, if necessary, into a position in which its free end is spaced apart from the apex being considered of the triangle by an angle between −60° and +60°.

Such a feature is particularly advantageous, since it permits a vertical take-off and landing of the drone, the three axes of the rotors being positioned substantially vertically during these phases. This feature also permits, outside the take-off and landing phases, a flight with an airplane aerodynamics, namely thanks to the lift of its shell, perfectly stable and consistently flat throughout its duration, the axes of two of the rotors being positioned substantially horizontally and the third rotor being capable of moving to some extent towards the left or the right in a substantially horizontal plane in order to stabilize the device. This permits both to avoid the large space required for the “delta wing”-type drones, then to take perfectly flat photographs of an impeccable quality.

According to a feature of the drone according to the invention, each of said arms is actuated by a servomotor connected to said supply means.

Furthermore, each actuator controls an arm by means of spacers including ball bearings.

According to a preferred variant embodiment of the invention, said frame is defined by a frame delimiting a recess for at least one accessory to be carried in said drone.

The drone according to the invention may in addition include a wrapping covering the frame.

In this case, said wrapping preferably includes two side portions defining wings and a central body having an upper face and a lower face provided with an opening for accessing said recess.

The present invention also provides for the possibility of providing the drone with arms having different lengths.

Said arms may also include means capable of permitting their interchangeability.

The present invention will be better understood when reading the description of an exemplary embodiment with reference to the attached figures.

### BRIEF DESCRIPTION OF THE SEVERAL VIEWS OF THE DRAWINGS

FIG. 1 illustrates a top plan view of a drone according to the invention, covered in a wrapping, its rotors being arranged according to the configuration in which it has an airplane aerodynamics outside the take-off and landing phases.

FIG. 2 illustrates a bottom plan view of the drone of FIG. 1.

FIG. 3 illustrates a side elevation view of the drone of FIG. 1, the angle of inclination of one of its rotors being modified.

FIG. 4 represents a top plan view of the drone of FIG. 1 without its wrapping and its rotors.

FIGS. 5 to 7 are side schematic views of the drone of FIG. 1 without its wrapping and without its rotors, illustrating various possible inclinations of its rotors.

FIGS. 8 to 10 are upper perspective views from above the drone of FIG. 1 without its wrapping and without its rotors, illustrating various inclinations of its rotors.

### DETAILED DESCRIPTION OF THE INVENTION

When referring to the figures, the present invention relates to a drone 1, of the tricopter type, aimed at being sent within a geographical area, for example to fly over a geographical area having a particular interest, in order to produce photographic views of the area.

The drone 1 according to the invention includes a frame 2, preferably made of carbon and/or plastic or composite material or any equivalent material that is both lightweight and resistant to eventual shocks. In the variant embodiment shown, the frame 2 is defined by two identical plates 24, 25, facing each other, connected to each other by a plurality of spacers 26 and forming a frame, for example with a substantially triangular shape, delimiting at its center a recess 3.

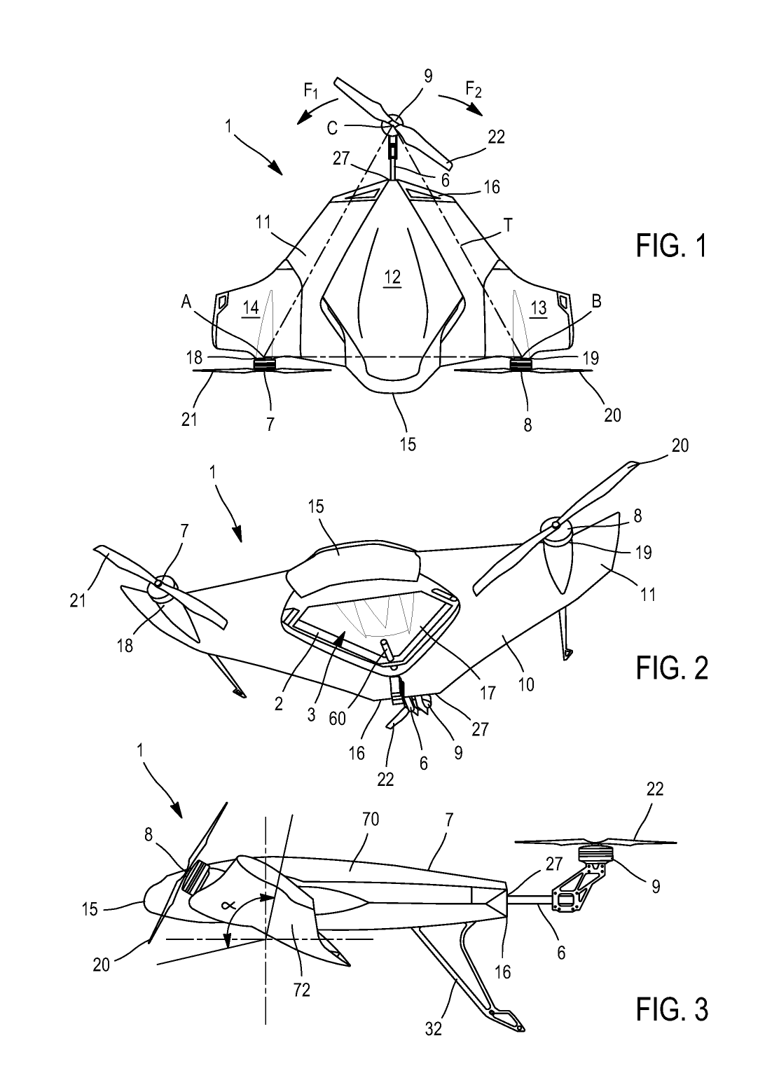

Three arms 4, 5, 6, preferably made of carbon and/or a plastic or composite material or any equivalent material, are connected by one of their ends 40, 50, 60 to the frame 2, such that they extend in the plane of the frame 2 and that their free ends 41, 51, 61 are each located at an apex A, B, C of an imaginary triangle T (see FIG. 1) the length of the sides of which is for example between 500 mm and 900 mm. Of course, such dimensions are given only by way of an example and may of course be changed in order to provide a drone 1 according to the invention with a different size adapted to the application being considered.

Conventionally, each free end 41, 51, 61 of an arm 4, 5, 6 is integral with a rotor 7, 8, 9, with an axis perpendicular to said arm 4, 5, 6, including blades 20, 21, 22, and driven in rotation by a motor connected to a battery (not shown) accommodated in the drone 1.

On the other hand, the frame 2 is coated with a wrapping 11, for example made of PPE, or of a plastic or composite material with equivalent properties, forming a central body 12 from which extend two side wings 13, 14.

The central body 12 has a nose 15 and a shank 16. The latter includes an orifice 27 from which emerges at least partially the arm 6 extending to the rear of the drone 1 in motion, and the free end 61 of which is integral with the rotor 9.

The lower face 10 of the central body 12 includes an opening 17 providing access to the recess 3 of the frame 2, and which permits to accommodate the accessories of the drone 1, such as namely electronic control means, specific sensors, supply means, etc., selected according to the needs. When appropriate, the recess 3 can be closed by means of a cover (not shown) closing the opening 17. It then advantageously provides perfect protection of accessories that are received therein, including during landing or in the event untimely fall of the drone 1.

The wrapping 7 also includes two side wings 71, 72 independent from the central body 12 and covering the two arms 4, 5 extending in front of the drone 1 in motion. In fact, the front edge of each of the wings 13, 14 includes an orifice 18, 19 for the passing through of the axis of the rotors 7, 8 integral with the free ends 41, 51 of the arms 4, 5.

The drone 1 according to the invention also includes a foot 32 fastened under his tail 16 and permitting to make cause it to rest on a support, for example on the ground after its landing.

According to the invention, the arms 4, 5, 6 are pivotally mounted relative to the frame 2 and are each connected by their ends 40, 50, 60 to a servomotor 28, 29, 30, coupled to electronic means for controlling the drone 1. Indeed, the servomotors 28, 29, 30 are accommodated between the plates 24, 25 forming the frame 2. They control the arms 4, 5, 6 through spacers provided with ball bearings. Advantageously, the arms 4, 5, 6 are thus designed capable of pivoting, automatically and namely depending on the information detected by the sensors the drone 1 is provided with, between different positions while driving during their rotation the rotors 7, 8, 9 they support.

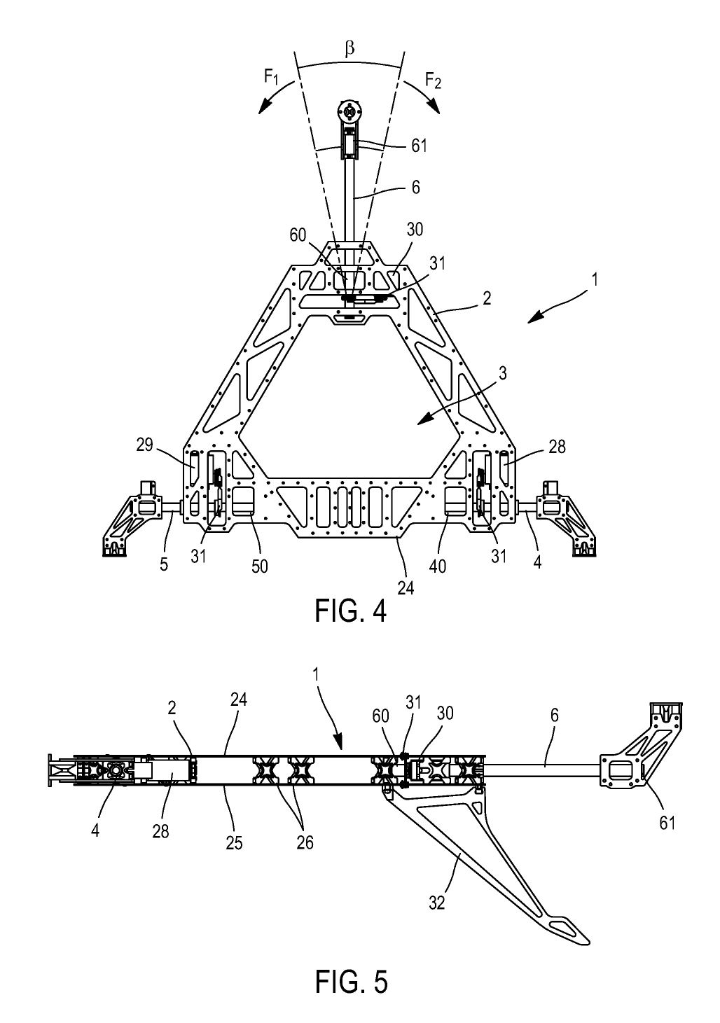

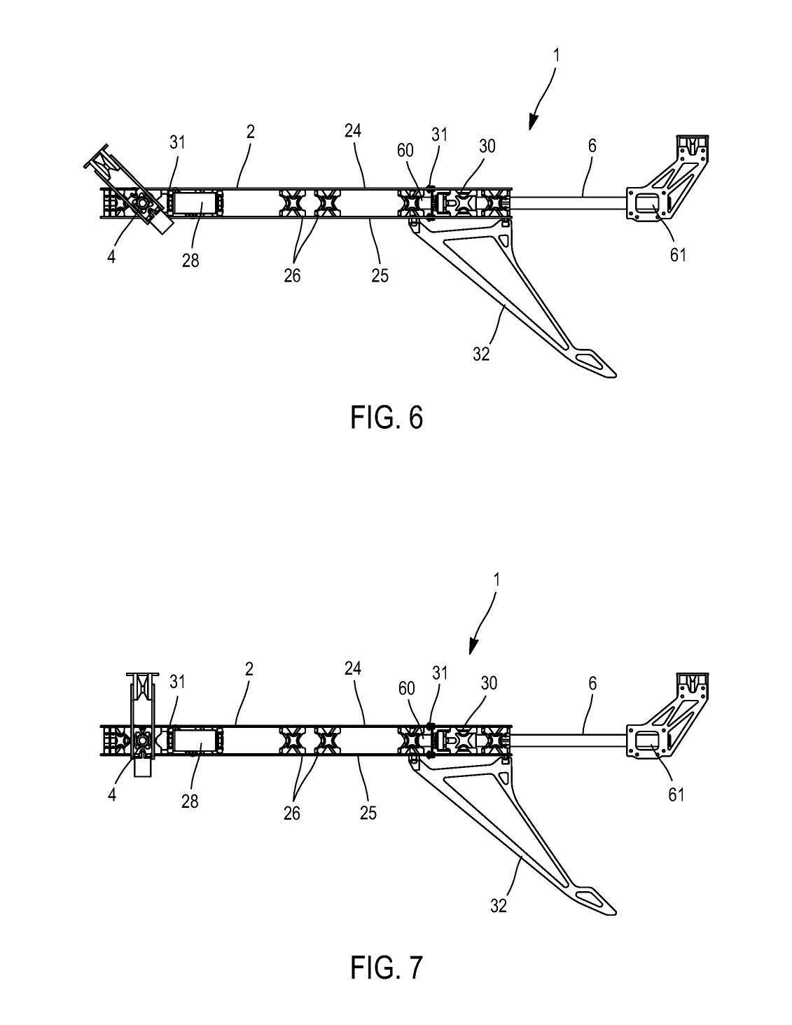

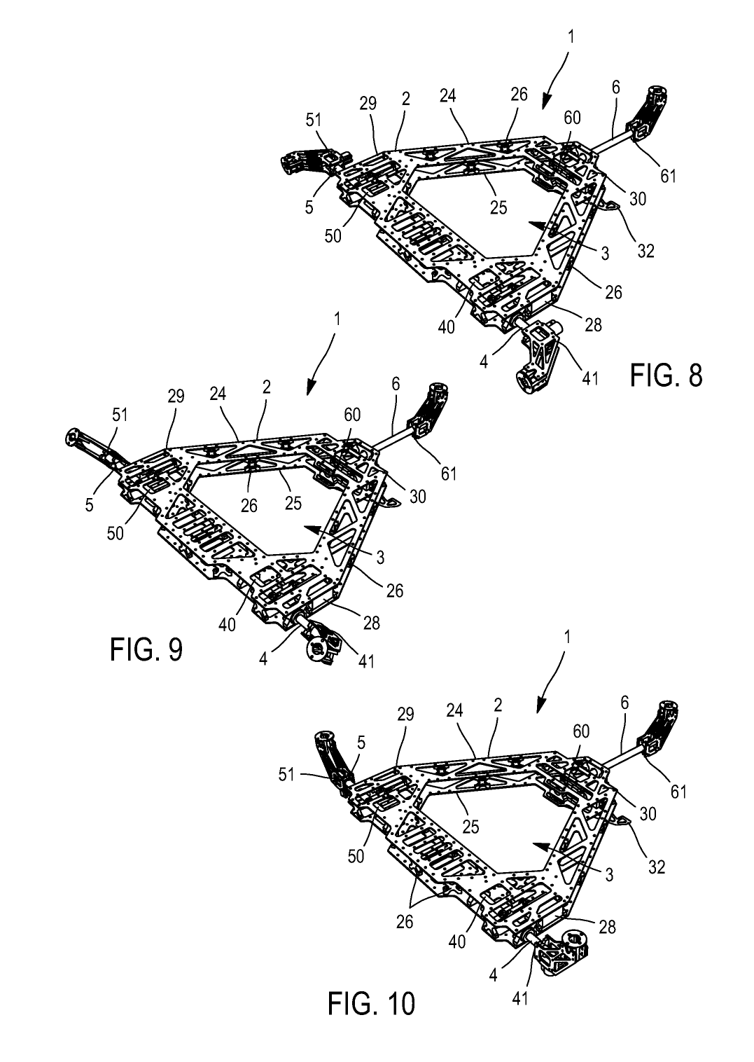

In fact, the present invention has provided that the arms 4, 5 are capable of pivoting so as to drive the rotor 7, 8 supported by their free ends 41, 51 into any position in which the axis of said rotor 7, 8 forms an angle a between −30° and +150° with the plane of the frame 2, while the arm 6 is capable of pivoting, if necessary, in the direction of the arrows F1 and F2 (see FIGS. 1 and 4) into a position in which its free end 61 is spaced apart from the apex C being considered of the triangle T by an angle β between 60° and +60°.

Thanks to such a feature, the axes of the rotors 7, 8, 9 of the drone 1 are automatically oriented depending on the requirements of the flight, in order to guarantee the flatness of same at any moment outside the take-off and landing phases.

Furthermore, in order to have a vertical take-off and landing, permitting space saving, it is provided, during these phases, to automatically place the axes of the rotors 7, 8 substantially perpendicular to the plane of the frame 2, which is then in turn substantially horizontal. Therefore, during the take-off and landing phases, the three axes of the rotors 7, 8, 9 are substantially vertical and their blades 20, 21, 22 rotate in substantially horizontal planes.

After take-off, when the desired altitude has been reached, the axes of the rotors 7, 8 are automatically and progressively placed, through an appropriate rotation of the arms 4, 5, parallel to the plane of the frame 2, i.e. substantially horizontally. In this position, the blades 20, 21 rotate in substantially vertical planes and the drone 1 adopts an airplane aerodynamics improving the lift on it and increasing its autonomy, the side wings 13, 14 extending in the plane of the central body 12. The drone 1 according to the invention includes in addition mechanical and electronic means permitting to guarantee that the tilting between the position permitting a vertical take-off and position permitting a horizontal translation motion occurs gradually, because the lift must then be transferred from the rotors 7, 8, 9 to the side wings 13, 14. Now, the latter do play their role only as from the moment at which the drone 1 has reached a determined horizontal speed.

In order to maintain the desired position of the drone 1, the angles a and 13 can be changed during the flight, based on the information collected at any time by the on-board sensors (accelerometers, gyroscopes, compasses) and processed by the electronic control means. It should be noted that the angle a formed by the axis of the rotor 7 with the plane of the frame 2 may be different from that formed by the axis of the rotor 8 with this same plane. Such a feature permits to achieve a stationary flight with an inclined pitch and therefore to take photographs of perfect quality of buildings such as namely bridges from below.

In some variant embodiments, the drone 1 of the invention can be provided with arms 4, 5, 6 simply clipped onto the frame 2, which requires no tools for the assembly or disassembly operations. This permits their interchangeability, for example in case of damage. In addition, although in the example described the arms 4, 5, 6 have a same length, it is quite conceivable to provide the drone 1 with arms 4, 5, 6 which differ from each other by their length, which improves its flexibility.

Of course, many modifications can be made to the examples described above without departing from the scope of the present invention.

1. A tricopter-type rotary wing drone, comprising:
three arms connected to a frame through one of their ends and extending in the plane of the frame according to a configuration in which their free ends are each located at an apex of a triangle; and
a rotor supported by each of the free ends with an axis perpendicular to said free end and driven in rotation by a motor connected to supply means,
wherein said arms are pivotally mounted on said frame,
wherein two of them automatically driving the rotor supported by their free end into a position in which its axis forms an angle between −30° and +150° with the plane of the frame, and
wherein the third of them automatically pivoting, if necessary, into a position in which its free end is spaced apart from the apex being considered of the triangle by an angle between −60° and +60°.

2. The drone, according to claim 1, wherein each of said arms is actuated by a servomotor connected to said supply means.

3. The drone, according to claim 2, wherein each servomotor controls an arm by spacers including ball bearings.

4. The drone, according to claim 1, wherein said frame is defined by a frame defining a recess for at least one accessory aimed at being carried in the drone.

5. The drone, according to claim 1, further comprising: a wrapping covering the frame.

6. The drone, according to claim 5, wherein said wrapping includes two side portions defining wings and a central body having an upper face and a lower face provided with an opening for accessing said recess.

7. The drone, according to claim 1, wherein said arms have different lengths.

8. The drone, according to claim 1, wherein said arms are comprised of means capable of permitting their interchangeability.
